(19) United States
(12) Patent Application Publication
(10) Pub. No.: US 2026/0291620 A1
(43) Pub. Date: Sep. 24, 2026

(54) System and Method for Secure Communication at a Speed Faster Than Light

(71) Applicants: Gautam SHARMA, Santa Monica, CA (US); Artham GUPTA, New Delhi (IN)

(72) Inventors: Gautam SHARMA, Santa Monica, CA (US); Artham GUPTA, New Delhi (IN)

(21) Appl. No.: 19/046,546

(22) Filed: Feb. 6, 2025

(51) Int. Cl. H04B 10/70; H04J 3/06

(52) U.S. Cl. CPC H04B 10/70; H04J 3/0638

(57) ABSTRACT

The present invention describes a system and technique that utilizes Quantum Entanglement to enable completely secure communication that occurs at a speed faster than light. Based on this invention, the entanglement of particles can be exploited to transmit information instantaneously, i.e. at a speed faster than light, across large distances, with no scope of any unwanted interference or illegal intervention of any nature whatsoever.

### FIELD OF THE INVENTION

The present invention describes a system and technique that utilizes Quantum Entanglement to enable completely secure communication that occurs at a speed faster than light. Based on this invention, the entanglement of particles can be exploited to transmit information instantaneously, i.e. at a speed faster than light, across large distances, with no scope of any unwanted interference or illegal intervention of any nature whatsoever.

### BACKGROUND AND PRIOR ART

Quantum Entanglement is a property of Quantum mechanics where two or more particles become linked, such that the state of one instantly determines the state of the other, no matter the distance between them. For instance, consider two entangled particles (e.g., photons, electrons, atoms or the like). If one were to measure a property of one of the quantum entangled particle (e.g., its spin or polarization), the state of the other quantum entangled particle immediately becomes determined, no matter what the distance of separation is between such pair of quantum entangled particles, i.e. even if they are light-years apart. This happens due to the principle of Quantum superposition, which states that each particle (such as an electron or a photon) exists in a combination of multiple possible states at the same time until it is measured. The measurement “collapses” the state for both particles simultaneously and instantaneously. The Quantum state of two entangled particles can be written as:

$${{{{\vert Ψ 〉 = \frac{1}{\sqrt{2}} ( \vert 0 〉}_{A} \vert 1 〉}_{B} + \vert 1 〉}_{A} \vert 0 〉}_{B} )$$

This means:
If particle A is measured as 0, particle B must be 1.
If A is 1, then B is 0.
No matter how far apart they are, these values will be correlated when measured, as stated above.

For the purpose of explanation, in classical physics, objects exist in a single definite state (e.g., a coin is either heads or tails). Whereas, in Quantum mechanics, a system can be in a superposition of both states simultaneously (e.g., the coin is both heads and tails at the same time). When measured, the system collapses into one definite state. In classical computing, a bit can be 0 or 1. A Quantum bit (qubit) can exist in a superposition of both 0 and 1:

$$\vert ψ 〉 = α \vert 0 〉 + β \vert 1 〉$$

where α and β are probability amplitudes that determine the likelihood of measuring 0 or 1.

This can be further understood by a famous thought experiment known as the Schrodinger's Cat. It is based on an imagination of a cat inside a box with a mechanism that has a 50% chance of killing it. Until one opens the box, the cat is in a superposition of being both alive and dead. However, the act of observing the cat forces the system to collapse into one definite state.

Quantum Entanglement is one of the most fascinating phenomena in physics. It plays a crucial role in Quantum communication, but it has never been used as a method for faster-than-light (FTL) communication. Rather, there is a large body of work that discards the use of quantum communication at a speed faster than light. Entanglement has potential applications in Quantum communication, including Quantum cryptography, Quantum teleportation, and Quantum networks.

For instance, consider two entangled electrons with spin states, wherein spin can be up (↑) or down (↓). If one creates a pair of entangled electrons, their spin must be opposite (one up and one down). Before measurement, each electron exists in a superposition of both states. As stated above, mathematically, this entangled state will be written as:

$${{{{\vert ψ 〉 = \frac{1}{\sqrt{2}} ( \vert ↑ 〉}_{A} \vert ↓ 〉}_{B} + \vert ↓ 〉}_{A} \vert ↑ 〉}_{B} )$$

This implies that if Alice and Bob each possess one electron, which are quantum entangled, then if Alice measures her electron and finds it to have a spin-up (↑), she immediately knows that Bob's electron must be spin-down (↓). This correlation holds true even if Alice and Bob are light-years apart.

Given the importance of Quantum Entanglement, superposition allows Quantum computers to process multiple possibilities simultaneously. Quantum Entanglement can further be used in communication in several ways, and some of them are mentioned hereinbelow for ease of reference:
a) Quantum Key Distribution—Ultra-Secure Communication: Quantum Entanglement can be used to distribute encryption keys in a completely secure manner. For instance, if two persons (Alice and Bob) share entangled particles, they measure their particles in randomly chosen bases. If an eavesdropper (Chris) tries to intercept, the entanglement is disturbed, revealing the attack. If no interference is detected, Alice and Bob generate a secure key based on their measurement results. The result is that both Alice and Bob have a perfect secure encryption key that no eavesdropper can copy. There are several devices, which uses such type of communication, including BB84 Protocol (using Quantum states, not entanglement), E91 Protocol (uses entanglement for key distribution) and China's Micius satellite successfully demonstrated QKD between ground stations over 1,200 km, proving entanglement can be used for secure global communications.
b) Quantum Teleportation—Transmitting Quantum Information: Quantum teleportation allows the transfer of Quantum states from one location to another using entanglement and classical communication. For instance, if Alice and Bob share an entangled pair, and Alice wants to send a Quantum state, |ψ [symbol] (e.g., a qubit), to Bob. Alice performs a joint measurement on its particle and the Quantum state |ψ [symbol] , collapsing its system. Then, Alice sends the classical measurement result to Bob. Thereafter, Bob, using this information, applies a transformation to its entangled particle, reconstructing |ψ [symbol] exactly. Quantum teleportation transfers Quantum information without physically moving the particle itself. Quantum teleportation has been demonstrated over long distances (over 1,400 km via satellites). However, it has as limitation that it requires a classical communication, i.e., no faster than light transmission can happen.
c) Quantum Networks—The Foundation for a Quantum Internet: Quantum Entanglement can be used to link multiple Quantum processors or nodes in a network, forming a Quantum internet. For instance, Entanglement is distributed among distant nodes. Quantum repeaters maintain entanglement over long distances, which in turn secure Quantum communication or allows distributed Quantum computing to be performed. Direct transmission of entanglement is limited by photon loss in fiber optics (~100 km). Quantum repeaters extend entanglement by creating entangled links over short distances and using entanglement swapping to extend entanglement over long distances. Scientists are working on Quantum networks to enable ultra-secure communication between cities and eventually global-scale Quantum internet.

An example of Quantum Entanglement involves a light source that emits two photons at a time. Those two photons of a pair can be entangled so that the polarizations of the individual photons can have any orientation (i.e., random), but photons of a pair always have matching polarizations, which are inherently linked. The polarization of light depends on the electric field of the light wave. As the light travels from one point to another, its electric field will oscillate transversely to that propagation direction. It might oscillate in the vertical plane, in the horizontal plane or any direction in between. Therefore, the polarization of each photon (the direction in which its electric field oscillates) can be random and take any orientation. However, when one photon is measured, the polarization of its entangled twin will always be correlated with it, even if they are separated by great distances. This means that even if the individual polarization states are unpredictable, both photons in a pair will always show matching polarizations when measured.

As stated above, Quantum Entanglement describes a strange bond that can form between two particles, even when separated by huge distances. Information about their Quantum states can become so inextricably linked that looking at one particle can tell you about the other, and even influence changes in it instantly, no matter how far away they are from each other.

A Quantum internet could allow data to be transferred instantaneously around the world, and far more securely than it is now—after all, if a hacker tries to intercept a message, the act of observing it garbles the data.

Despite its instantaneous nature, till now Quantum Entanglement has not been exploited for transmitting messages faster than light for the following reasons:
a) No control over measurement outcomes: When measuring an entangled particle, the result is random (50% chance of 0 or 1). Since the outcome is unpredictable, one cannot encode a message in the measurement. For instance, Alice and Bob share entangled photons. Alice wants to send “HELLO” by choosing whether her photon collapses to 0 or 1. But she cannot choose the outcome as it is inherently random.
b) Need for classical communication: Even if Alice and Bob share entangled particles, Bob cannot decode Alice's message without additional classical information. It is relevant to note that Classical signals travel below the speed of light. For instance, in Quantum teleportation, Alice must send classical bits to Bob before he can reconstruct the Quantum state. This means information still follows relativistic speed limits.
c) No signal can be extracted from a single measurement: Bob cannot look at his entangled particle and determine what Alice did without classical confirmation. The correlations only become evident after comparing results, which requires a classical channel.

Therefore, a system and a method is required, which could overcome the problems associated with earlier developed techniques, especially one that uses quantum entangled particles, and particularly one that could enable faster than light communication.

### AIMS AND OBJECTIVES

The objective of the present invention is to develop a system and method that can leverage quantum entanglement to enable faster-than-light (FTL) communication in a completely secure manner. The proposed system and method aims to use the unique properties of entangled particles to transmit information instantaneously, surpassing the speed limitations imposed by earlier known communication systems and methods, in a completely secure manner.

### SUMMARY OF THE INVENTION

The present invention relates to a communication system and method that enables faster-than-light (FTL) communication in a completely secure manner in which there is no scope for any illegal interception of communication or unwanted interference with the communication system. The communication system as per the present invention comprises of (a) a pair of particles, which are in a state of quantum entanglement with each other (shown as P1 and P2 in FIG. 1); (b) a pair of synchronization devices, which are synchronized with each other with respect to time (shown as A1 and A2 in FIG. 1); (c) a pair of observation devices that are observing the state of each of the particles of the said pair of particles (shown as O1 and O2 in FIG. 1), each of the observation devices being controlled by a corresponding computing device (shown as CD1 and CD2 in FIG. 1), which would monitor the synchronization devices associated with the observation devices, such that a signal can be sent to the observation devices to make an observation at the relevant/appropriate time determined by the synchronization devices; (d) a pair of devices, i.e., a transmitter and a receiver (shown in FIG. 1), each of them being present at the two terminals of communication (shown as L1 and L2 in FIG. 1), wherein each of the devices of the said pair of devices contain (i) one of the particles of the said pair of quantum entangled particles (shown as P1 at the transmitter and as P2 at the receiver in FIG. 1), (ii) one of the synchronization devices of the said pair of synchronization devices (shown as A1 at the transmitter and as A2 at the receiver in FIG. 1), (iii) one of the observation devices of the said pair of observation devices (shown as O1 at the transmitter and as O2 at the receiver in FIG. 1); and (iv) one computing device (shown as CD1 at the transmitter and as CD2 at the receiver in FIG. 1). The present invention allows communication between the transmitter and receiver by means/method of: (a) making changes, at the transmitter, whenever required, to the state of the first particle (shown as P1 in FIG. 1) of the said pair of particles by observing it, using the first observation device (shown as O1 in FIG. 1) of the said pair of observation devices, in between a certain pre-determined regular interval of time (shown more particularly in FIG. 3) measured by the first synchronization device (shown as A1 in FIG. 1) of the said pair of synchronization devices; (b) observing, at the receiver, the state of the second particle (shown as P2 in FIG. 1) of the said pair of particles by using the second observation device (shown as O2 in FIG. 1) of the said pair of observation devices, exactly at the pre-determined regular interval of time (shown more particularly in FIG. 3) measured by the second synchronization device (shown as A2 in FIG. 1) of the said pair of synchronization devices; (c) repeating steps (a) and (b) to achieve the desired communication using any communication protocol.

In a preferred embodiment of the present invention, the communication system comprises of: (a) more than one pair of particles (such pairs shown as P1A-P1B, P2A-P2B . . . . PNA-PNB, in FIG. 2), in which each such pair comprises of particles, which are in a state of quantum entanglement with each other (for example, P1A and P1B are quantum entangled with each other, as shown in FIG. 2); (b) a pair of synchronization devices, which are synchronized with each other with respect to time (shown as A1 and A2 in FIG. 2); (c) more than one pair of observation devices that are observing the state of each of the particles of each of the pairs of particles (such pair of observation devices shown as O1A-O1B, O2A-O2B, . . . . ONA-ONB, in FIG. 2, with O1A observing P1A . . . . ONA observing PNA, O1B observing P1B . . . . ONB observing PNB), each such observation device being controlled by a corresponding computing device (shown as CD1 and CD2 in FIG. 2), which would monitor the synchronization devices associated with the observation devices, such that a signal can be sent to the observation devices to make an observation at the relevant/appropriate time determined by the synchronization devices; (d) a pair of communication control interface (shown as CCI 1 and CCI 2 in FIG. 2); (e) a pair of devices, i.e., a transmitter and a receiver (shown in FIG. 2), each of them being present at the two terminals of communication (shown as L1 and L2 in FIG. 2), wherein each of the devices of the said pair of devices contain (i) one of the particles of each of the said more than one pair of quantum entangled particles (shown as P1A, P2A . . . . PNA at the transmitter and as P1B, P2B . . . . PNB at the receiver in FIG. 2), (ii) one of the synchronization devices of the said pair of synchronization devices (shown as A1 at the transmitter and as A2 at the receiver in FIG. 2), (iii) one of the observation devices of each of the said more than one pair of observation devices that observe the particles of the said more than one pair of quantum entangled particles (shown as O1A, O2A . . . . ONA at the transmitter and as O1B, O2B . . . . ONB at the receiver in FIG. 2); (iv) one computing device (shown as CD1 at the transmitter and as CD2 at the receiver in FIG. 2) and (v) a communication control interface (shown as CCI 1 at the transmitter and as CCI 2 at the receiver in FIG. 2). This embodiment of the present invention allows communication between the transmitter and receiver by means/method of: (a) making changes, at the transmitter, whenever required, to the state of each of the first particles of the said more than one pair of particles (shown as P1A, P2A, . . . . PNA, at the transmitter in FIG. 2) by observing each of such first particles of the said more than one pair of particles, using each of the associated first observation devices of the said more than one pair of observation devices (shown as O1A, O2A . . . . ONA, at the transmitter in FIG. 2), in-between a certain pre-determined regular interval of time (shown more particularly in FIG. 3) measured by the first synchronization device of the said pair of synchronization devices (shown as A1 at the transmitter in FIG. 2); (b) observing, at the receiver, the state of each of the second particles of the said more than one pair of particles (shown as PIB, P2B . . . . PNB at the receiver in FIG. 2), by using each of the associated second observation devices of the said more than one pair of observation devices (shown as O1B, O2B . . . . ONB at the receiver in FIG. 2), exactly at the pre-determined regular interval of time (shown more particularly in FIG. 3) measured by the second synchronization device of the said pair of synchronization devices (shown as A2 at the receiver in FIG. 2); (c) repeating steps (a) and (b) to achieve the desired communication.

The present invention allows faster than light communication (in the form words, sentences, graphics, sound or means of communication and/or data transfer) between two locations that could be even be light-years apart in a completely secure manner.

### DESCRIPTION OF DRAWINGS

FIG. 1: Illustration of a transmitter and a receiver according to the present invention.

FIG. 2: Illustration of a transmitter and a receiver having multiple quantum entangled particles according to a preferred embodiment of the present invention.

FIG. 3: Diagrammatic representation of the point in time that an observation is to be made at the transmitter and receiver as per the present invention.

FIGS. 4A and 4B: Illustration of the method, by which the transmitter sends communication to the receiver.

FIG. 5: Diagrammatic representation of another exemplary and illustrative embodiment of the present invention.

FIG. 6: Diagrammatic representation of an exemplary and illustrative embodiment of the present invention.

FIG. 7: Diagrammatic representation of another exemplary and illustrative embodiment of the present invention.

### DETAILED DESCRIPTION OF THE INVENTION

As has been stated hereinabove, the issue with the existing communication devices and methods using Quantum Entanglement is that while measuring the state of a photon at the destination, even if the state is changing with the change of state of the photon at the source, the data gathered is random and meaningless since no one knows the initial state of the transmitting photon and there is no means to channelize the data. Although Quantum Entanglement ensures that two particles share a correlated state, meaning that if one particle's state changes, the other reflects that change, however, this does not mean that useful information can be transmitted. When measuring the state of an entangled photon at the receiver (destination), the result is completely random. Even if this measurement is affected by the source photon, the receiver at the destination cannot determine any useful information because they do not know the original state of the photon that was transmitted.

Unlike classical signals where data is explicitly encoded (e.g., Morse code, electrical pulses), entanglement measurements do not produce structured, meaningful information. For example, if Alice (the sender) measures a photon's polarization, she gets a random result. If Bob (the receiver) measures his entangled photon, he also gets a random result. Even though their results are correlated, Bob cannot distinguish whether Alice has performed a measurement or not. Since patterns or structured messages cannot be encoded, entanglement alone does not allow for communication. To extract useful information, Alice would need to send additional classical information (such as a phone call or email) to tell Bob what measurement was performed. Since classical communication is limited by the speed of light, faster-than-light messaging remained impossible. As discussed earlier, such communication was also prone to being intercepted or being interfered with.

The present invention relates to a novel technology designed to resolve the limitations found in existing quantum entanglement-based communication methods. It aims to overcome the challenges that currently prevent entangled particles from being used for practical data transmission. It also provides for a communication system and method in which there is no scope for any illegal interception of communication or unwanted interference with the communication system.

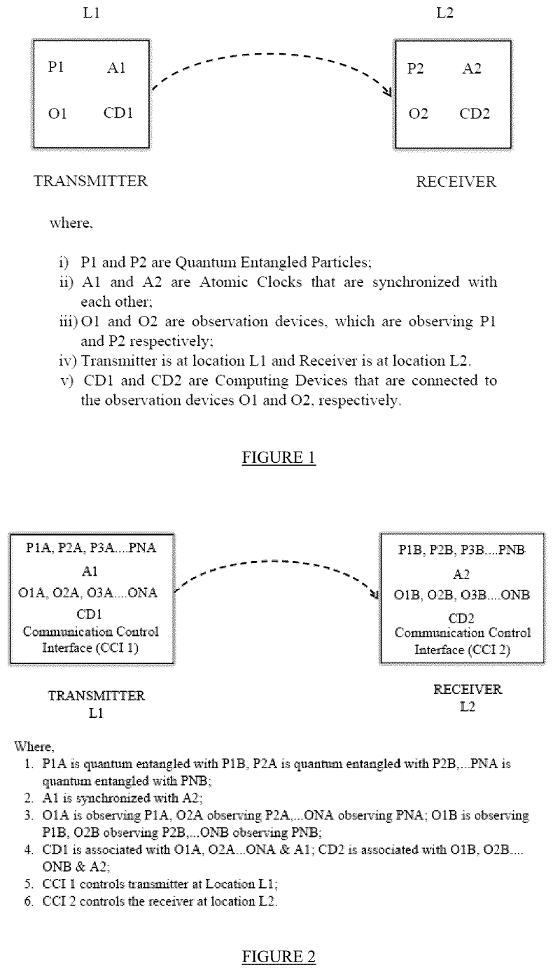

The present invention uses particles that are quantum entangled. These particles include electrons, photons and other sub-atomic particles. The nature and size of the particle is not a limitation of the present invention, so long as the particles are capable of being quantum entangled, they can be used as per the system and method described in the present invention. Each of these particles is represented in FIG. 1 as P1 and P2 for exemplary purposes only.

The synchronization devices of the present invention can include atomic clocks or any other instrument/device that is capable of keeping/measuring time accurately or any other whatsoever device that can perform the function of telling/keeping time at regular intervals. Each of these synchronization devices is represented in FIG. 1 as A1 and A2 for exemplary purposes only. These would include devices such as a pair of atomic clocks, which are synchronized with each other such that they would always tell/keep the exact same time and are capable of telling/keeping time at regular intervals. This means that when A1 would read ‘Time 1’, A2 would also read ‘Time 1’ with complete precision, when A1 would read ‘Time 2’, A2 would also read ‘Time 2’ with complete precision, and so on. For clarity, the following illustrations can also be considered:
i) If the synchronization device A1 says T0, then the synchronization device A2 is also T0.
ii) If the synchronization device A1 says T1, then the synchronization device A2 is also T1.
iii) If the synchronization device A1 says T2, then the synchronization device A2 is also T2.
iv) If the synchronization device A1 says T3, then the synchronization device A2 is also T3.
v) If the synchronization device A1 says T4, then the synchronization device A2 is also T4.
vi) If the synchronization device A1 says T5, then the synchronization device A2 is also T5.
vii) If the synchronization device A1 says Tn, then the synchronization device A2 is also Tn.

These atomic clocks ensure that the time interval at which the two quantum entangled particles are being observed as per this invention are in sync with each other. This in-turn ensures that meaningful, protected, secure, useful and comprehendible communication can be achieved based on the observed changes to the state of the pair of quantum entangled particles. As will be explained below, the first particle of the pair of quantum entangled particles is observed in-between the pre-determined time intervals [T0 and T1, T1 and T2, T2 and T3, . . . . T(n−1) and T(n)] measured by the first synchronization device [shown as A1 in FIG. 1], and the second particle of the pair of quantum entangled particles is observed at the pre-determined time intervals [T0, T1, T2, T3 . . . . Tn] measured by the second synchronization device [shown as A2 in FIG. 1]. For clarity, this is explained in FIG. 3 for exemplary and illustrative purposes only. For clarity again, the following explanation can also be considered with reference to FIG. 1 and FIG. 3:
i) Particle P1 would be observed only between T0 and T1, but never at T0 or T1.
ii) Particle P2 would be observed only at T0 and T1, but never between T0 or T1.

The observation devices used in the present invention would be an instrument/device that is capable of measuring the state of the quantum particles and includes a Stern-Gerlach apparatus or a polarization analyzer or any other instrument/device that is capable of measuring the state of particles that can be quantum entangled. These observation devices would observe the state of the entangled particles, as per the present invention. Each of these observation devices are represented in FIG. 1 as O1 and O2.

Each of the observation devices would be controlled by a high-speed computing device [shown as CD1 and CD2 in FIG. 1], which would also be monitoring the synchronization device such that a signal can be sent to the observation device to make an observation at the relevant/appropriate time as determined by the synchronization device and as required for the message to be communicated, as per the present invention.

The system of the present invention comprises of at least two devices, i.e., a transmitter and a receiver [shown in FIG. 1], with each of them being present at the two terminals of communication [shown as L1 and L2 in FIG. 1]. Each of the said devices contain (a) at least one of the particles of the pair of quantum entangled particles [P1 and P2] as shown in FIG. 1, (b) at least one of the synchronization devices of the pair of synchronization devices [A1 and A2] as shown in FIG. 1, and (c) at least one of the observation devices of the pair of observation devices [O1 and O2] as shown in FIG. 1. It is not necessary for the said particle, synchronization device and observation device, which are at one of the terminals of communication, to be contained in a single physical device. They may be present together at one of the two terminals of communication in such a manner that all these components function in the manner described herein.

### Embodiments of the Present Invention

The system of the present invention, as discussed above, allows data transfer at a speed greater than the speed of light in a completely secure manner, by way of the following method, which may be construed as one of the embodiments of the present invention:

### a) STEP 1

Create a pair of photons entangled at the quantum level [shown as P1 and P2 in FIG. 1], with opposite spins (or states), say ‘0’ and ‘1’. P1 can have only two states, i.e., ‘0’ and ‘1’. Given the nature of quantum entangled particles, if P1 is ‘1’, then P2 is ‘0’. Similarly, if P1 is ‘0’, then P2 is ‘1’. In other words, P1 and P2 are locked in opposite phase. If P1 is changed from ‘1’ to ‘0’, then P2 changes from ‘0’ to ‘1’ at the same time (and vice versa).

### b) STEP 2

Initialize two atomic clocks [shown as A1 and A2 in FIG. 1] at the same time so that they are synchronized exactly with each other. For accuracy, both clocks are reset to read 0.0 together at the same time before being sent to the two different locations [shown as L1 and L2 in FIG. 1]. These two clocks A1 and A2 are always synchronized such that they always tell/keep the same time without any drift whatsoever. Thus, both A1 and A2 would read time TO, T1, T2 Tn at the exact same time.

### c) STEP 3

Photon P1, Atomic Clock A1, Observation Device O1 and Computing Device CD1 are put together as the Transmitter and taken to Location L1, whereas Photon P2, Atomic Clock A2, Observation Device O2 and Computing Device CD2 are put together as the Receiver and taken to Location L2 (shown more particularly in FIG. 1). Prior to taking the Transmitter and Receiver to their respective locations, the state of Photon P1 and Photon P2 are noted and fed into the respective computing devices.

### d) STEP 4

In this embodiment, Photon P1 and Photon P2 will be observed in the manner described above. For this embodiment only, the regular time interval is considered as 5 microseconds. For this embodiment only, the smallest interval of time that can be accurately measured by the atomic clocks A1 and A2 is considered to be 0.1 microseconds. The pair of entangled particles are observed at the pre-determined interval of time, which is measured accurately by the synchronization devices using the respective observation devices that are controlled by the respective computing devices. These computing devices monitor the synchronization devices associated with the observation devices, such that a signal can be sent to the observation devices to make an observation at the relevant/appropriate time (shown more particularly in FIG. 3) determined by the synchronization devices.

### e) STEP 5

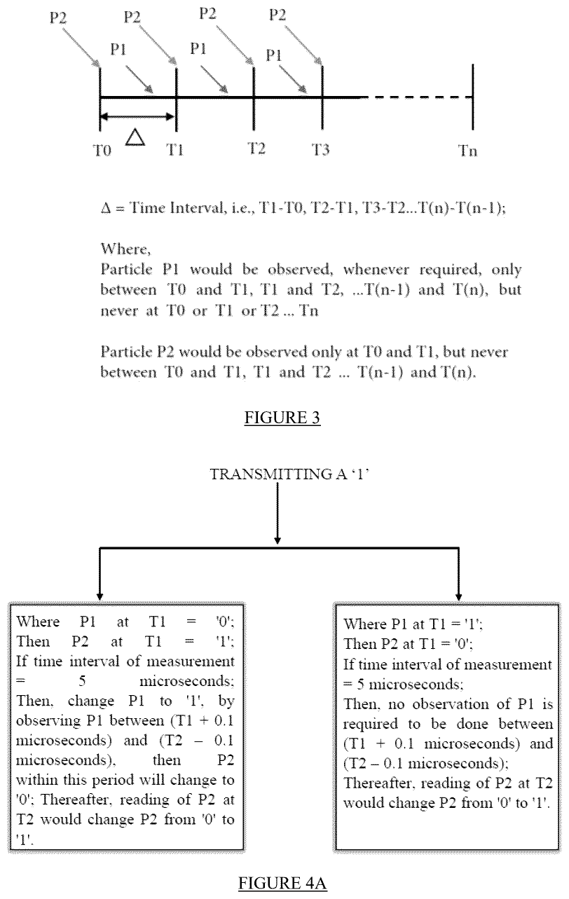

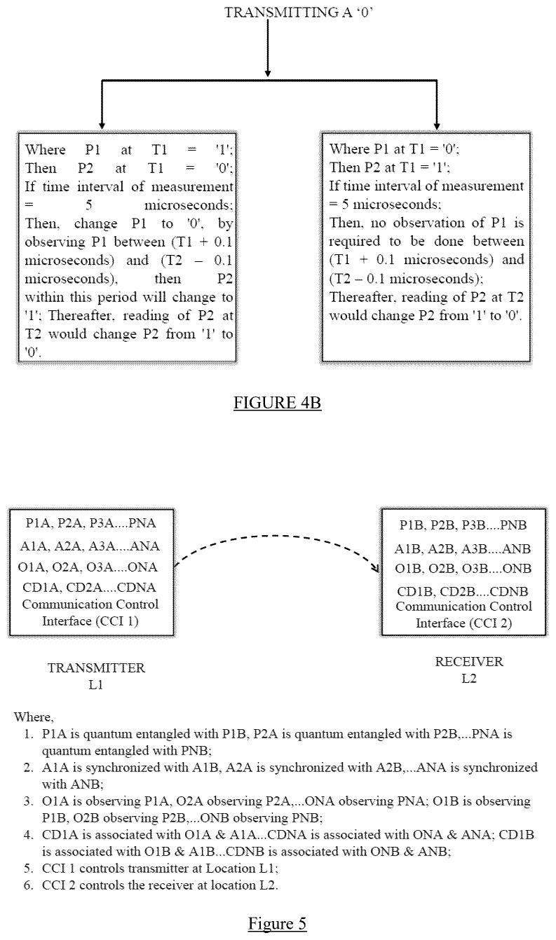

If the Transmitter wants to transmit a signal of ‘0’ to the Receiver at time T2 (shown more particularly in FIG. 4B), then:
   i) It is necessary to ensure that Photon P2 at the Receiver is in state ‘1’ immediately prior to time T2 such that when Photon P2 is observed at time T2, it changes from state ‘1’ to state ‘0’-‘0’ being the final message intended to be communicated to the Receiver (as stated above).
   ii) To ensure that Photon P2 is in state ‘1’ immediately prior to time T2, Photon P1 will have to observed in-between the time period T1 and T2 such that the state of Photon P1 is ‘0’ and correspondingly the state of
   Photon P2 is ‘1’.
iii) In this embodiment, where the smallest interval of time that can be accurately measured by the atomic clocks A1 and A2 is considered to be 0.1 microseconds, the transmitter has between (T1+0.1 microseconds) and (T2−0.1 microseconds) to observe Photon P1 such that the state of Photon P1 is ‘O’ and the state of Photon P2 is ‘1’. This is because in this embodiment, the smallest accurate measurement of time of the atomic clocks A1 and A2 is 0.1 microseconds (as stated above). Further, as stated above, the difference between T1 and T2 is 5 microseconds for exemplary purposes only.
   iv) If the state of Photon P1 is already ‘0’ and correspondingly the state of Photon P2 is ‘1’, then the Transmitter will not make any observations at Photon P1 between (T1+0.1 microseconds) and (T2−0.1 microseconds). This is because upon observation at T2, the state of Photon P2 will change from ‘1’ to ‘0’, which is the final message intended to be communicated to the Receiver (as stated above).
   v) If the state of Photon P1 is ‘1’, then the Transmitter will observe Photon P1 between (T1+0.1 microseconds) and (T2−0.1 microseconds) such that the state of Photon P1 becomes ‘0’, and the corresponding state of Photon P2 becomes ‘1’. This will ensure that when Photon P2 is observed at T2, the state of Photon P2 will change to ‘0’, which is the final message intended to be communicated to the Receiver (as stated above).
If the Transmitter wants to transmit a signal of ‘1’ to the Receiver at time T2 (shown more particularly in FIG. 4A), then:
   i) It is necessary to ensure that Photon P2 at the Receiver is in state ‘0’ immediately prior to time T2 such that when Photon P2 is observed at time T2, it changes from state ‘0’ to state ‘1’-‘1’ being the final message intended to be communicated to the Receiver (as stated above).
   ii) To ensure that Photon P2 is in state ‘0’ immediately prior to time T2, Photon P1 will have to observed between the time period T1 and T2 such that the state of Photon P1 is ‘1’ and correspondingly the state of Photon P2 is ‘0’.
   iii) In this embodiment, the transmitter has between (T1+0.1 microseconds) and (T2−0.1 microseconds) to observe Photon P1 such that the state of Photon P1 is ‘1’ and the state of Photon P2 is ‘0’.
   iv) If the state of Photon P1 is already ‘1’ and correspondingly the state of Photon P2 is ‘0’, then the Transmitter will not make any observations at Photon P1 between (T1+0.1 microseconds) and (T2−0.1 microseconds). This is because upon observation at T2, the state of Photon P2 will change from ‘0’ to ‘1’, which is the final message intended to be communicated to the Receiver (as stated above).
   v) If the state of Photon P1 is ‘0’, then the Transmitter will observe Photon P1 between (T1+0.1 microseconds) and (T2−0.1 microseconds) such that the state of Photon P1 becomes ‘1’, and the corresponding state of Photon P2 becomes ‘0’. This will ensure that when Photon P2 is observed at T2, the state of Photon P2 will change to ‘1’, which is the final message intended to be communicated to the Receiver (as stated above).

### f) STEP 6

If the Transmitter wants to send a message of ‘0111000001111111101100’, the steps mentioned above will be performed in sequence.

The above steps can be combined to send and receive communication using any communication protocol.

In another embodiment of the above, the Receiver would know that the Transmitter has started a communication when a pre-determined message such as ‘000000’ is received at the Receiver. The message after ‘000000’ would be the actual message/communication sought to be sent by the Transmitter to the Receiver. Similarly, the Receiver would know that the Transmitter has ended a communication when a pre-determined message such as ‘000000″ is received at the Receiver. For example, if the word ‘hello’ has to be communicated by the Transmitter to the Receiver, this word would, for exemplary purposes, translate to ‘000000’+‘010001’+‘001011’+‘011001’+‘011001’+‘011111’+‘000000’. The final sequence of numbers to be transmitted in this example would be ‘000000010001001011011001011001011111000000’. Thus, when the first sequence of 6 ‘0's’ are received at the Receiver, it would be known that all the 0's and 1's that follow after the 6 ‘0's’ is the actual data. When the Receiver encounters another set of 6 ‘0's’ again, it is a signal to the Receiver that the communication has ended. Therefore, when the 6 ‘0's’ in the beginning and at the end are removed, the real data string would display the message to be conveyed.

In another embodiment of the above, if the first state of the message to be sent at the Receiver is ‘1’, the transmitter would first send a sequence of multiple ‘0's’ (6 in this example), which would indicate that a message is about to be sent. If the first state of the message to be sent at the Receiver is ‘0’, the transmitter would first send a sequence of multiple ‘1's’ (6 in this example), which would indicate that a message is about to be sent. If the last state of the message to be sent at the Receiver is ‘1’, the transmitter would first send a sequence of multiple ‘0's’ (6 in this example), which would indicate that the message is over. If the last state of the message to be sent at the Receiver is ‘0’, the transmitter would first send a sequence of multiple ‘1's’ (6 in this example), which would indicate that the message is over. Thus, the Receiver would know that the Transmitter has started or ended a communication when a string of 6's, which is opposite to the last state of the message, is observed by the Receiver. Thus, if the first state of the message is ‘1’, the Transmitter would send ‘000000’, after which would be the actual message/communication sought to be sent by the Transmitter to the Receiver. Similarly, if the last state of the message is ‘1’, the Transmitter would send ‘000000’, which would signal to the Receiver that the Transmitter has ended the communication. If the first state of the message is ‘0’, the Transmitter would send ‘111111’, after which would be the actual message/communication sought to be sent by the Transmitter to the Receiver. Similarly, if the last state of the message is ‘0’, the Transmitter would send ‘111111’, which would signal to the Receiver that the Transmitter has ended the communication. In this embodiment, Photon P2 is being regularly observed at the pre-determined interval of time. For example, if the word ‘hello’ has to be communicated by the Transmitter to the Receiver, this word would, for exemplary purposes, translate to ‘111111’+‘010001’+‘001011’+‘011001’+‘011001’+‘011111’+‘000000’. The final sequence of be numbers to transmitted in this example would be ‘111111010001001011011001011001011111000000’. This is because the first state of the actual message was ‘0’ and the last state of the actual message was ‘1’.

In another embodiment of the present invention, the Receiver can be linked to an AI tool for the purpose of overcoming any error in communication.

In another embodiment of this invention, communication can take place through multiple transmitter and receiver pairs, which would be controlled by a standard communication control interface (CCI 1 and CCI 2) at each of the multiple transmitter end and multiple receiver end. This would result in higher bandwidth communication. Thus, in the above example, where the word ‘hello’ has to be communicated, the same can take place, for exemplary purposes, through multiple transmitter and receiver pairs such that each of the transmitter and receiver pairs would simultaneously send a message, which would be organized in a pre-programmed manner by the communication control interface.

In another embodiment of this invention, communication can take place through more than one pairs of quantum entangled particles, as shown in more detail in FIG. 2 and in other portions hereinabove. This would result in higher bandwidth communication. Thus, in the above example, where the word ‘hello’ has to be communicated, the same can take place, for exemplary purposes, through more than one pairs of quantum entangled particles such that each of these more than one pairs of quantum entangled particles would simultaneously send a message, which would be organized in a pre-programmed manner by the communication control interface.

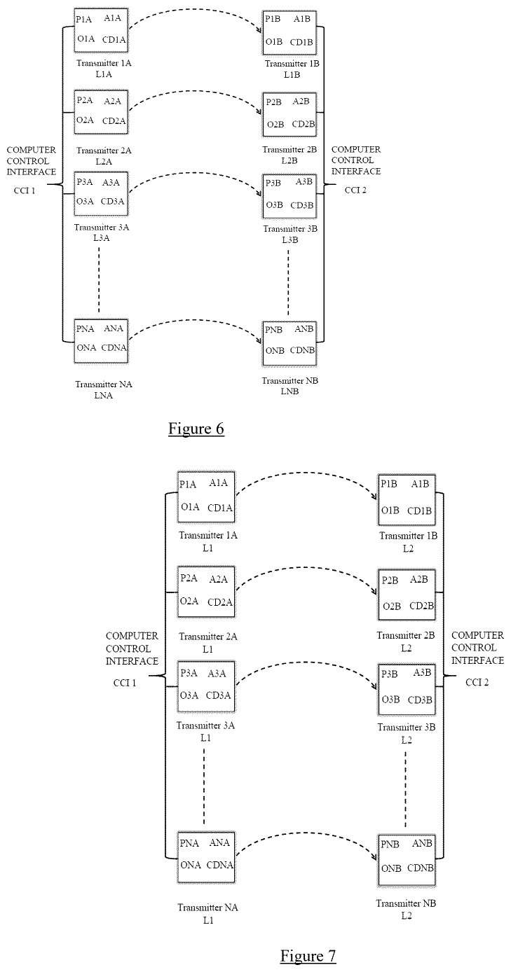

In another embodiment, communication can take place through multiple transmitter and receiver pairs, wherein these multiple transmitter and receiver pairs are located at different locations, such as shown in FIG. 6. In another embodiment, communication can take place through multiple transmitter and receiver pairs, wherein all these multiple transmitters are located at one location, and all the multiple receivers are located at another location, as shown in FIG. 7.

In another embodiment, one particle of each pair of the multiple quantum entangled particles (P1A, P2A, P3A . . . . PNA), the associated synchronization device (A1), their associated observation devices (O1A, O2A, O3A . . . . ONA), the associated computing device (CD1), would be controlled by a standard communication control interface (CCI 1) at the Transmitter, located at location L1, whereas the other particle of each pair of the multiple quantum entangled particles (P1B, P2B, P3B . . . . PNB), the associated synchronization device (A2), their associated observation devices (O1B, O2B, O3B . . . . ONB), the associated computing device (CD2), would be controlled by another standard communication control interface (CCI 2) at the Receiver, located at Location L2. [See FIG. 2]

In another embodiment, one particle of each pair of the multiple quantum entangled particles (P1A, P2A, P3A . . . . PNA), their associated synchronization devices (A1A, A2A, A3A . . . . ANA), their associated observation devices (O1A, O2A, O3A . . . . ONA), their associated computing devices (CD1A, CD2A, CD3A . . . . CDNA), would be controlled by a standard communication control interface (CCI 1) at the Transmitter, located at location L1, whereas the other particle of each pair of the multiple quantum entangled particles (P1B, P2B, P3B . . . . PNB), their associated synchronization devices (A1B, A2B, A3B . . . . ANB), their associated observation devices (O1B, O2B, O3B . . . . ONB), their associated computing devices (CD1B, CD2B, CD3B . . . . CDNB), would be controlled by another standard communication control interface (CCI 2) at the Receiver, located at Location L2. [See FIG. 5]

The above system and method would allow FTL communication (in the form words, sentences, graphics, sound or means of communication and/or data transfer) between two points that could be light-years apart. For example, the above system and method would allow FTL communication between a terminal located on Earth and the other terminal located on Mars. Such communication currently takes between 4 minutes 30 seconds to 21 minutes as per publicly available data. This long communication time is one of the main reasons why human landing on Mars has not been achieved till date. FTL communication using the system and method of this invention between a terminal located on Earth and the other terminal located on Mars would allow for safer landings on Mars for humans, and eventually pave the way for human life to be cultivated on Mars.

Further, in the recent past there has been grave concern regarding the possibility of communication being intercepted/hacked. These fears have especially grown with the ability of quantum computers to intercept/hack even highly encoded or highly secure messages in minutes—as opposed to the several years that super computers used to take. Regular communication means are vulnerable to interception/hacking because they communicate over the internet or over physical cables or other such means. The system and method of the present invention provides completely secure communication means since there is no physical connection between the communicating terminals-thereby securing against any illegal intercepting/hacking of communication.

Moreover, there is a fear that communication satellites/communication means used for communication may be interfered with/blocked, which would render all existing communication networks useless. Since the system and method of the present invention requires only a transmitter and receiver at the terminals of communication, such transmitter and receiver can be shielded from unwanted electromagnetic pulses by way of radiation shields, which would ensure that there is no unwanted interference with communication.

The summary above, as well as the detailed description of illustrative embodiments, is better understood when read in conjunction with the appended drawings. For the purpose of illustrating the present disclosure, exemplary constructions of the disclosure are shown in the drawings. However, the present disclosure is not limited to specific instrumentalities disclosed herein.

As required, detailed embodiments and drawings of the present disclosure as disclosed herein are merely exemplary of the disclosure which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

I/We claim:

1. A communication system comprising:
a) a pair of particles, which are in a state of quantum entanglement with each other;
b) a pair of synchronization devices, which are synchronized with each other with respect to time;
c) a pair of observation devices that are observing the state of each of the particles of the said pair of particles, each of the observation devices being controlled by a corresponding computing device, which would monitor the synchronization devices associated with the observation devices, such that a signal is capable of being sent to the observation devices to make an observation at the relevant/appropriate time determined by the synchronization devices;
d) a pair of devices, i.e., a transmitter and a receiver, each of them being present at the two terminals of communication,
wherein each of the devices of the said pair of devices contain (i) one of the particles of the said pair of quantum entangled particles, (ii) one of the synchronization devices of the said pair of synchronization devices, (iii) one of the observation devices of the said pair of observation devices; and (iv) one computing device.
whereby communication is achieved between the transmitter and receiver by means of:
e) making changes, at the transmitter, whenever required, to the state of the first particle of the said pair of particles by observing it, using the first observation device of the said pair of observation devices, in between a certain pre-determined regular interval of time measured by the first synchronization device of the said pair of synchronization devices;
f) observing, at the receiver, the state of the second particle of the said pair of particles by using the second observation device of the said pair of observation devices, exactly at the pre-determined regular interval of time measured by the second synchronization device of the said pair of synchronization devices;
g) repeating steps (e) and (f) to achieve the desired communication.

2. A method for communication comprising the communication system claimed in claim 1, whereby communication is achieved between the transmitter and receiver by means of:
a) making changes, at the transmitter, whenever required, to the state of the first particle of the said pair of particles by observing it, using the first observation device of the said pair of observation devices, in between a certain pre-determined regular interval of time measured by the first synchronization device of the said pair of synchronization devices;
b) observing, at the receiver, the state of the second particle of the said pair of particles by using the second observation device of the said pair of observation devices, exactly at the pre-determined regular interval of time measured by the second synchronization device of the said pair of synchronization devices;
c) repeating steps (a) and (b) to achieve the desired communication.

3. A communication system comprising:
a) more than one pair of particles, in which each such pair comprises of particles, which are in a state of quantum entanglement with each other;
b) a pair of synchronization devices, which are synchronized with each other with respect to time;
c) more than one pair of observation devices that are observing the state of each of the particles of each of the pairs of particles, each such observation device being controlled by a corresponding computing device, which would monitor the synchronization devices associated with the observation devices, such that a signal is capable of being sent to the observation devices to make an observation at the relevant/appropriate time determined by the synchronization devices;
d) a pair of communication control interface;
e) a pair of devices, i.e., a transmitter and a receiver, each of them being present at the two terminals of communication,
wherein each of the devices of the said pair of devices contain (i) one of the particles of each of the said more than one pair of quantum entangled particles, (ii) one of the synchronization devices of the said pair of synchronization devices, (iii) one of the observation devices of each of the said more than one pair of observation devices that observe the particles of the said more than one pair of quantum entangled particles; (iv) one computing device and (v) a communication control interface;
whereby communication is achieved between the transmitter and receiver by means of:
f) making changes, at the transmitter, whenever required, to the state of each of the first particles of the said more than one pair of particles by observing each of such first particles of the said more than one pair of articles, using each of the associated first observation devices of the said more than one pair of observation devices, in-between a certain pre-determined regular interval of time measured by the first synchronization device of the said pair of synchronization devices;
g) observing, at the receiver, the state of each of the second particles of the said more than one pair of particles, by using each of the associated second observation devices of the said more than one pair of observation devices, exactly at the pre-determined regular interval of time measured by the second synchronization device of the said pair of synchronization devices;
h) repeating steps (f) and (g) to achieve the desired communication.

4. A method for communication comprising the communication system claimed in claim 3, whereby communication is achieved between the transmitter and receiver by means of:
a) making changes, at the transmitter, whenever required, to the state of each of the first particles of the said more than one pair of particles by observing each of such first particles of the said more than one pair of articles, using each of the associated first observation devices of the said more than one pair of observation devices, in-between a certain pre-determined regular interval of time measured by the first synchronization device of the said pair of synchronization devices;
b) observing, at the receiver, the state of each of the second particles of the said more than one pair of particles, by using each of the associated second observation devices of the said more than one pair of observation devices, exactly at the pre-determined regular interval of time measured by the second synchronization device of the said pair of synchronization devices;
c) repeating steps (a) and (b) to achieve the desired communication.

5. The communication system and method, as claimed in claim 3 and claim 4, wherein there are more than one pair of synchronization devices, such that each of the synchronization devices of the said more than one pair of synchronization devices are associated with each of the particles of the said more than one pair of particles.

6. The communication system and method, as claimed in claim 3 and claim 4, wherein there are more than one pair of computing devices, such that each of the computing device of said more than one pair of computing devices are associated with each of the observation devices of the said more than one pair of observation devices.

7. The communication system and method, as claimed in claim 1 to claim 4, wherein the particles, which are in a state of quantum entanglement with each other, are such as electrons, photons or any other particles that are capable of being quantum entangled.

8. The communication system and method, as claimed in claim 1 to claim 4, wherein the synchronization devices includes any device that are capable of performing the function of keeping/measuring time at a regular interval, and are capable of being configured to tell the same time across multiple devices, such as atomic clocks.

9. The communication system and method, as claimed in claim 1 to claim 4, wherein the observation devices includes any device that can perform the function of observing the state of quantum entangled particles, such as Gerlach apparatus or a polarization analyzer.

10. The communication system and method, as claimed in claim 1 to claim 4, wherein communication can take place through multiple pairs of a transmitter and a receiver.
